(19) United States
(12) Patent Application Publication
(10) Pub. No.: US 2024/0284482 A1
(43) Pub. Date: Aug. 22, 2024

(54) FORWARDING SIDELINK RESOURCE RESERVATION INFORMATION

(71) Applicant: QUALCOMM Incorporated, San Diego, CA (US)

(72) Inventors: Sourjya DUTTA, San Diego, CA (US); Tien Viet NGUYEN, Bridgewater, NJ (US); Gabi SARKIS, San Diego, CA (US); Kapil GULATI, Belle Mead, NJ (US); Shijun WU, San Diego, CA (US); Hui GUO, Beijing (CN)

(21) Appl. No.: 18/574,252

(22) PCT Filed: Aug. 18, 2021
(86) PCT No.: PCT/CN2021/113182

§ 371 Date: Dec. 26, 2023

(51) Int. Cl. H04W 72/25; H04W 28/26; H04W 72/02; H04W 72/0446

(52) U.S. Cl. CPC H04W 72/25; H04W 28/26; H04W 72/02; H04W 72/0446

(57) ABSTRACT

Various aspects of the present disclosure generally relate to wireless communication. In some aspects, a first user equipment (UE) may receive, on one or more sidelink channels, a set of messages indicating a corresponding set of resource reservations. Accordingly, the first UE may transmit, to a second UE, a resource information message that indicates a subset of the set of resource reservations. The first UE may select the subset, from the set of resource reservations, using a time window, a maximum quantity of resource reservations, a retransmission threshold, a hop count threshold, a resource/subchannel threshold, or a combination thereof.

### FIELD OF THE DISCLOSURE

Aspects of the present disclosure generally relate to wireless communication and to techniques and apparatuses for forwarding sidelink resource reservation information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a first user equipment (UE). The apparatus may include a memory and one or more processors coupled to the memory. The one or more processors may be configured to receive, on one or more sidelink channels, a set of messages indicating a corresponding set of resource reservations. The one or more processors may be further configured to transmit, to a second UE, a resource information message that indicates a subset of the set of resource reservations.

Some aspects described herein relate to an apparatus for wireless communication at a base station. The apparatus may include a memory and one or more processors coupled to the memory. The one or more processors may be configured to transmit, to a UE, at least one parameter to determine a subset, from a set of resource reservations, to include in a resource information message on one or more sidelink channels.

Some aspects described herein relate to a method of wireless communication performed by a first UE. The method may include receiving, on one or more sidelink channels, a set of messages indicating a corresponding set of resource reservations. The method may further include transmitting, to a second UE, a resource information message that indicates a subset of the set of resource reservations.

Some aspects described herein relate to a method of wireless communication performed by a base station. The method may include transmitting, to a UE, at least one parameter to determine a subset, from a set of resource reservations, to include in a resource information message on one or more sidelink channels.

Some aspects described herein relate to a non-transitory computer-readable medium that stores a set of instructions for wireless communication by a first UE. The set of instructions, when executed by one or more processors of the first UE, may cause the first UE to receive, on one or more sidelink channels, a set of messages indicating a corresponding set of resource reservations. The set of instructions, when executed by one or more processors of the first UE, may further cause the first UE to transmit, to a second UE, a resource information message that indicates a subset of the set of resource reservations.

Some aspects described herein relate to a non-transitory computer-readable medium that stores a set of instructions for wireless communication by a base station. The set of instructions, when executed by one or more processors of the base station, may cause the base station to transmit, to a UE, at least one parameter to determine a subset, from a set of resource reservations, to include in a resource information message on one or more sidelink channels.

Some aspects described herein relate to an apparatus for wireless communication. The apparatus may include means for receiving, on one or more sidelink channels, a set of messages indicating a corresponding set of resource reservations. The apparatus may further include means for transmitting, to a UE, a resource information message that indicates a subset of the set of resource reservations.

Some aspects described herein relate to an apparatus for wireless communication. The apparatus may include means for transmitting, to a UE, at least one parameter to determine a subset, from a set of resource reservations, to include in a resource information message on one or more sidelink channels.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example associated with a queue for sidelink resource reservation information, in accordance with the present disclosure.

FIG. 6 is a diagram illustrating an example associated with forwarding sidelink resource reservation information, in accordance with the present disclosure.

FIGS. 7 and 8 are diagrams illustrating example processes associated with forwarding sidelink resource reservation information, in accordance with the present disclosure.

FIGS. 9 and 10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

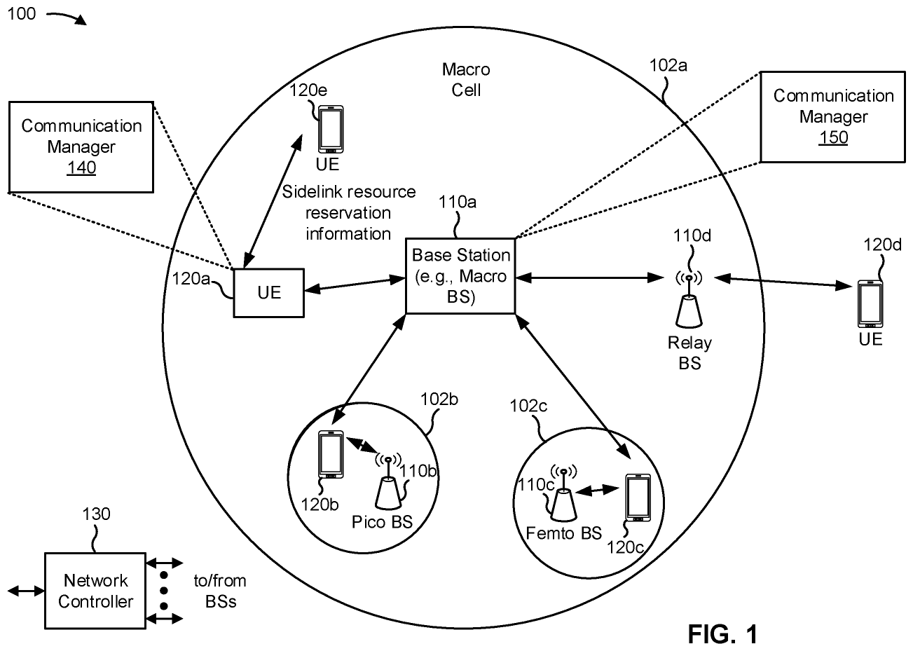

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120a may include a communication manager 140. As described in more detail elsewhere herein, the communication manager 140 may receive, on one or more sidelink channels, a set of messages indicating a corresponding set of resource reservations. Additionally, as shown in FIG. 1, the communication manager 140 may transmit, to a second UE (e.g., the UE 120e), a resource information message that indicates a subset of the set of resource reservations. Additionally, or alternatively, the communication manager 140 may perform one or more other operations described herein.

In some aspects, the base station 110 may include a communication manager 150. As described in more detail elsewhere herein, the communication manager 150 may transmit, to a UE (e.g., the UE 120a), at least one parameter to determine a subset, from a set of resource reservations, to include in a resource information message on one or more sidelink channels. Additionally, or alternatively, the communication manager 150 may perform one or more other operations described herein.

As indicated above, FIG. 1 is provided as an example. Other examples may differ from what is described with regard to FIG. 1.

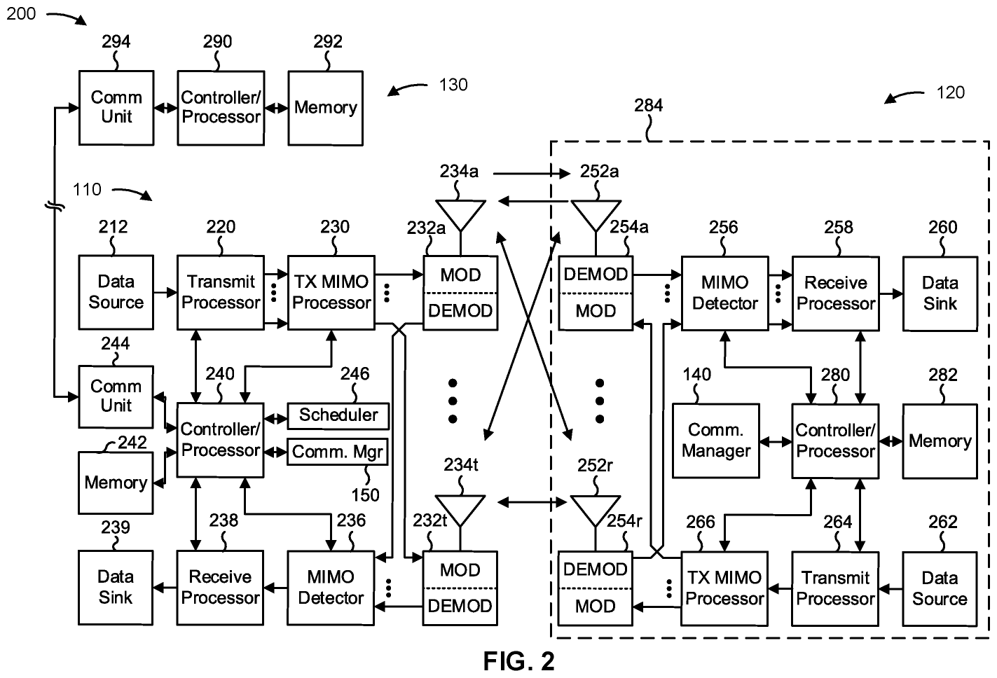

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

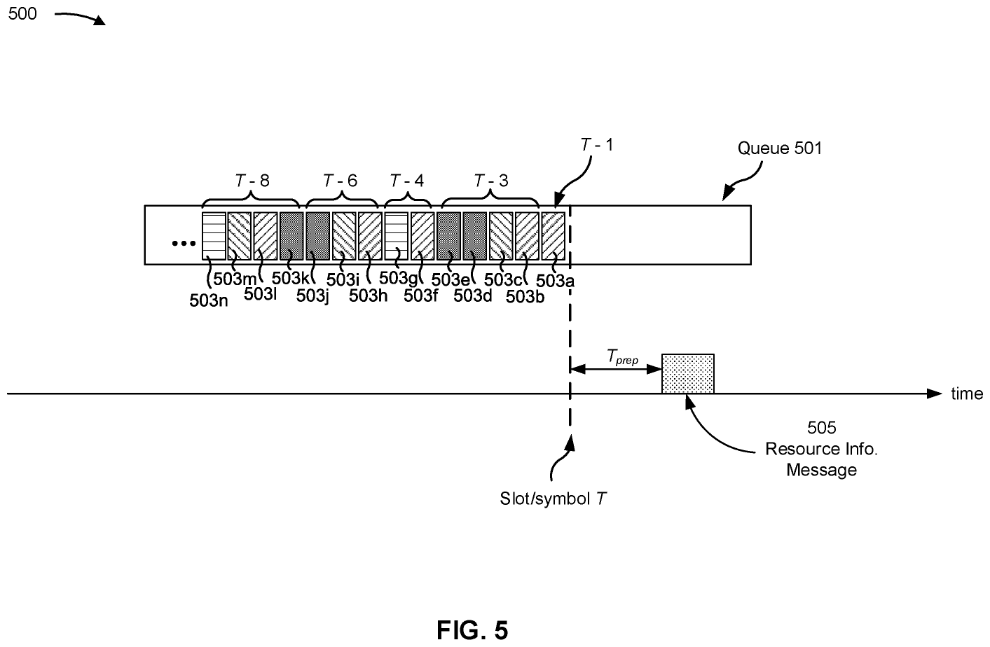

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

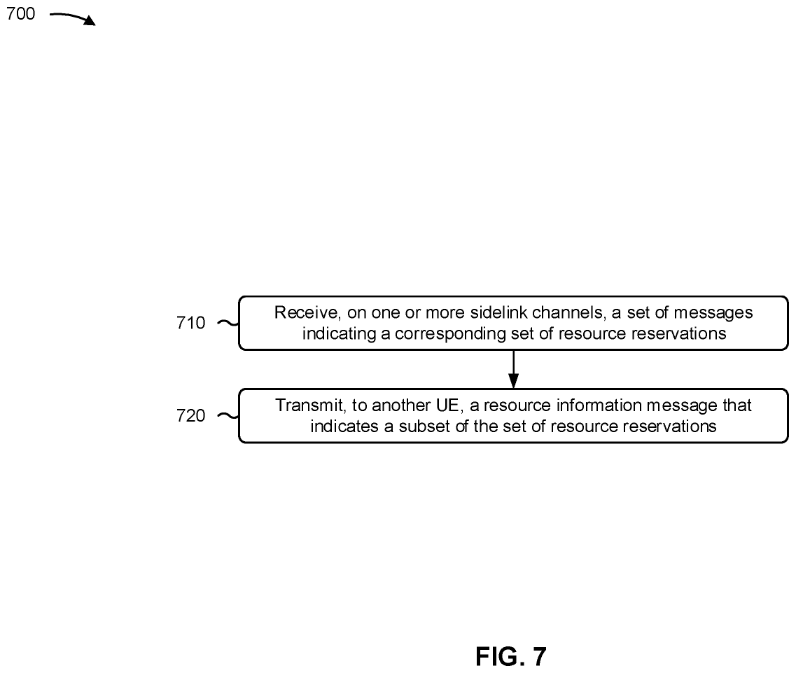

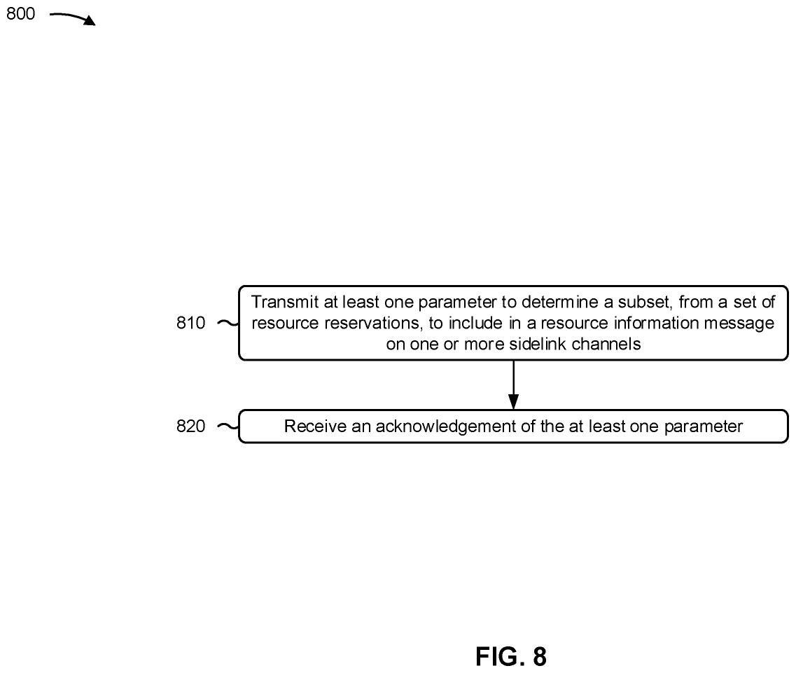

The controller/processor 240 of the base station 110, the controller/processor 280 of the UE 120, and/or any other component(s) of FIG. 2 may perform one or more techniques associated with forwarding sidelink resource reservation information, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

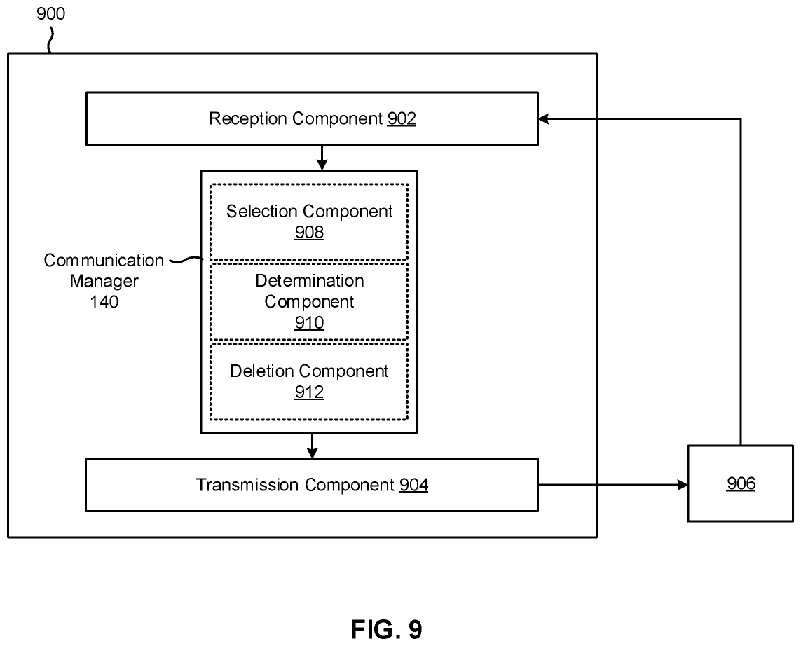

In some aspects, a first UE (e.g., the UE 120 and/or apparatus 900 of FIG. 9) may include means for receiving, on one or more sidelink channels, a set of messages indicating a corresponding set of resource reservations; and/or means for transmitting, to a second UE, a resource information message that indicates a subset of the set of resource reservations. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

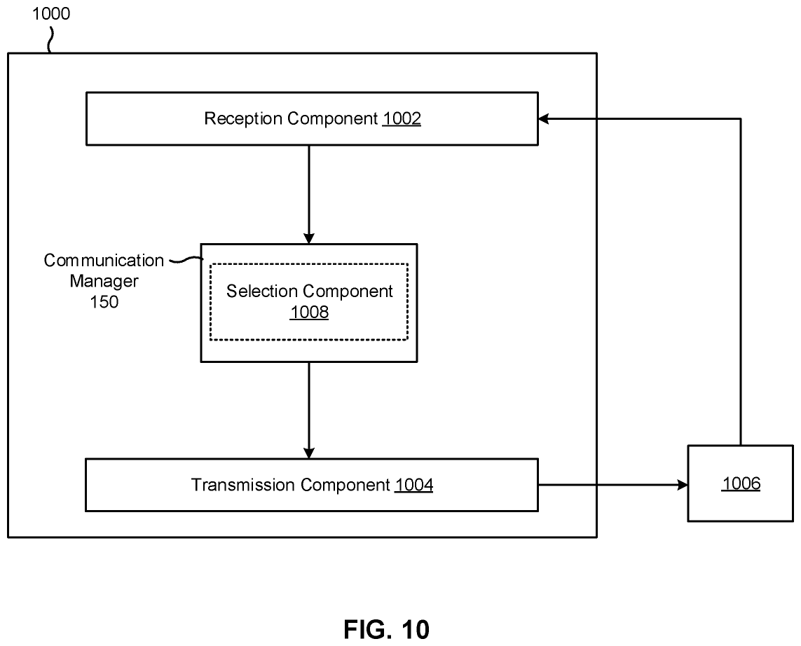

In some aspects, a base station (e.g., the base station 110 and/or apparatus 1000 of FIG. 10) may include means for transmitting, to a UE (e.g., the UE 120 and/or apparatus 900 of FIG. 9), at least one parameter to determine a subset, from a set of resource reservations, to include in a resource information message on one or more sidelink channels. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

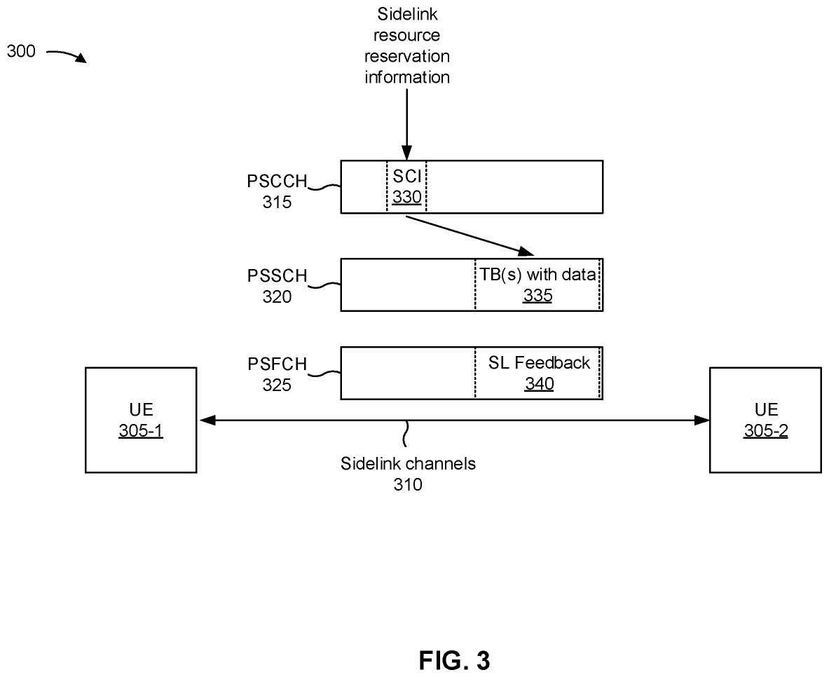

FIG. 3 is a diagram illustrating an example 300 of sidelink communications, in accordance with the present disclosure. As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

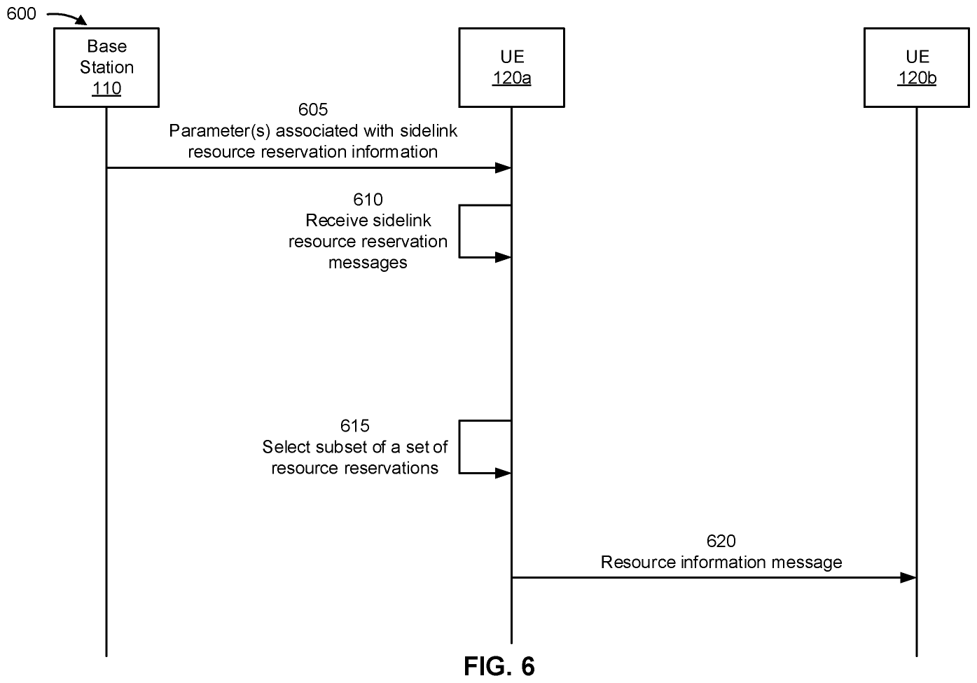

Accordingly, in some aspects, an SCI may indicate one or more resource reservations (e.g., in a frequency domain, such as RBs, in a time domain, such as slots and/or symbols, and/or in a spatial domain, such as beams and/or transmission configuration indicator (TCI) states). A UE (e.g., the UE 305-2) may receive SCI messages from a plurality of neighboring UEs. Accordingly, the UE 305-2 may determine a subset of resource reservations, from the set of resource reservations indicated by the set of received SCI messages, to forward to another UE (e.g., the UE 305-1), as described in connection with FIGS. 5 and 6.

As indicated above, FIG. 3 is provided as an example. Other examples may differ from what is described with respect to FIG. 3.

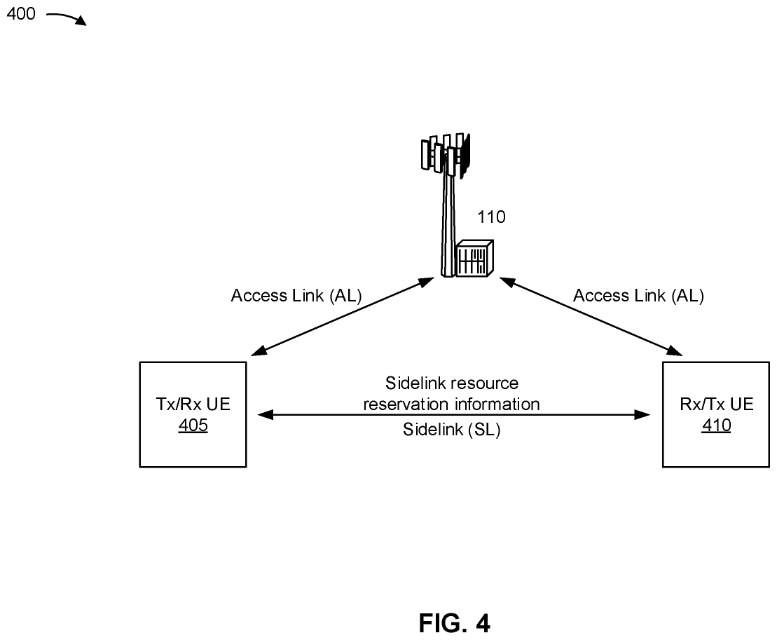

FIG. 4 is a diagram illustrating an example 400 of sidelink communications and access link communications, in accordance with the present disclosure. As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As shown in FIG. 4, one of the UEs 405 and 410 may indicate one or more resource reservations (e.g., in a frequency domain, such as RBs, in a time domain, such as slots and/or symbols, and/or in a spatial domain, such as beams and/or TCI states) to the other of the UEs 405 and 410 on the sidelink. Additionally, the other of the UEs 405 and 410 may receive messages indicating additional resource reservations from a plurality of neighboring UEs. Accordingly, the other of the UEs 405 and 410 may determine which resource reservations, from the additional resource reservations, to forward to the one of the UEs 405 and 410, as described in connection with FIGS. 5 and 6. In some aspects, the base station 110 may provide at least one parameter to the other of the UEs 405 and 410 to use in determining which resource reservations to forward, as described in connection with FIGS. 5 and 6.

As indicated above, FIG. 4 is provided as an example. Other examples may differ from what is described with respect to FIG. 4.

A UE may, on one or more sidelink channels, receive messages from other UEs indicating resources reserved by the other UEs. The UE may forward information indicating the reserved resources to another UE (e.g., a UE that will be transmitting to the UE on a sidelink channel and/or a nearby UE). However, forwarding the information expends power and processing resources. Additionally, forwarding the information consumes network resources on the sidelink channel and increases interference for nearby UEs.

Some techniques and apparatuses described herein enable a UE (e.g., UE 120a) to transmit (e.g., to a second UE, such as UE 120b) a resource information message indicating a subset of resource reservations out of a set of resource reservations associated with a corresponding set of messages received on one or more sidelink channels. As a result, the UE 120a conserves power and processing resources by reducing a quantity of resource reservations indicated in the resource information message. Additionally, reducing the quantity of resource reservations indicated in the resource information message conserves network resources on the sidelink channel and decreases interference for nearby UEs. In some aspects, the UE 120a may discard resource reservations that are not selected for the subset from a memory of the UE 120a to additionally reduce memory overhead at the UE 120a.

FIG. 5 is a diagram illustrating an example 500 associated with a queue for sidelink resource reservation information, in accordance with the present disclosure. As shown in FIG. 5, example 500 includes a queue 501 (e.g., within a memory of a UE, such as UE 120a) that stores resource reservations indicated by messages received at the UE 120a. For example, the UE 120a may receive, on one or more sidelink channels (e.g., as described in connection with FIGS. 3-4), a set of messages indicating a corresponding set of resource reservations that are stored in the queue 501. Although described with respect to a queue, the description similarly applies to using other data structures, such as a stack, an array, and/or a list, among other examples.

Accordingly, in example 500, the UE 120a received a set of messages (e.g., SCI messages) that indicate resource reservations 503a, 503b, 503c, 503d, 503e, 503f, 503g, 503h, 503i, 503j, 503k, 503l, 503m, and 503n. In FIG. 5, the queue 501 is shown as a time associated with a slot and/or a symbol that may be represented by T.

Accordingly, each resource reservation may be associated with a slot and/or symbol in which a corresponding message that indicated the resource reservation was received. In example 500, resource reservation 503a is associated with a slot and/or a symbol that may be represented by T-1, and resource reservations 503b, 503c, 503d, and 503e are associated with a slot and/or a symbol that may be represented by T-3. Similarly, resource reservations 503f and 503g are associated with a slot and/or a symbol that may be represented by T-4, and resource reservations 503h, 503i, and 503j are associated with a slot and/or a symbol that may be represented by T-6. Finally, resource reservations 503k, 503l, 503m, and 503n are associated with a slot and/or a symbol that may be represented by T-8.

The UE 120a may determine a subset, of the set of resource reservations, to include in a resource information message 505 (e.g., to transmit to another UE, such as a UE 120b). In some aspects, the subset of the set of resource reservations are associated with one or more messages, from the set of messages, that were received earlier than remaining messages, from the set of messages, associated with resource reservations, of the set of resource reservations, not included in the subset. Accordingly, as shown in FIG. 5, the queue 501 is organized chronologically such that the UE 120a may select more recent resource reservations, from the set of resource reservations, to include in the resource information message 505.

In some aspects, the UE 120a selects the subset of the set of resource reservations based at least in part on a maximum quantity of resource reservations. For example, the maximum quantity of resource reservations may be represented by N. Therefore, in one example, when N=7, the UE 120a selects resource reservations 503a, 503b, 503c, 503d, 503e, 503f, and 503g. In another example, when N=9, the UE 120a may select resource reservations 503a, 503b, 503c, 503d, 503e, 503f, and 503g and then include two of resource reservations 503h, 503i, and 503j based at least in part on signal strengths associated with the set of messages, distances associated with the set of messages, identifiers included in the set of messages, sizes associated with the set of resource reservations (e.g., TB sizes), amount of resources reserved with the set of messages (e.g., reservation sizes in frequency and/or time), periodicities of the resources reserved with the set of messages, or a combination thereof. For example, the UE 120a may select the two resource reservations associated with strongest signal strengths, shortest distances, largest sizes, larger amounts of resources, and/or shorter periodicities. Additionally, or alternatively, the UE 120a may prioritize any of the resource reservations 503h, 503i, and 503j associated with identifiers (e.g., UE IDs) included on a list stored in the memory of the UE 120a (e.g., a list of usual interferers). In some aspects, the UE 120a may generate a score using two or more of the factors described above and select the two resource reservations associated with highest scores. In some aspects, the UE 120a may discard, from the memory, stored data associated with resource reservations, from the set of resource reservations, that do not satisfy the maximum quantity. Accordingly, in example 500, the UE 120a may discard data associated with resource reservations 503k, 503l, 503m, and 503n. Accordingly, the UE 120a may reduce memory overhead.

In some aspects, the maximum quantity of resource reservations is a programmed (and/or otherwise preconfigured) value stored in the memory of the UE 120a (e.g., according to 3GPP specifications and/or another standard). Additionally, or alternatively, the maximum quantity of resource reservations may be indicated by a base station (e.g., as described in connection with FIG. 6). Additionally, or alternatively, the UE 120a may determine the maximum quantity of resource reservations based at least in part on a maximum transmission resource available, a maximum MCS, a fixed MCS, a network congestion parameter, a traffic pattern, an indication from an application layer of the UE 120a, or a combination thereof. For example, the UE 120a may select a higher maximum quantity of resource reservations based on a larger maximum transmission resource available, a larger maximum MCS (e.g., associated with a sidelink channel to be used), a larger fixed MCS (e.g., associated with the sidelink channel to be used), a larger network congestion parameter (e.g., a larger CBR), a traffic pattern (e.g., a larger data rate, a larger average packet size, a shorter periodicity, and/or a larger inter-arrival time associated with the one or more sidelink channels), an indication from an application layer of the UE 120a (e.g., an indication that higher reliability and/or quality, such as QoS, is required), or a combination thereof. In some aspects, the UE 120a may use a formula, a table, and/or another data structure that maps one or more of the factors described above to a value for the maximum quantity of resource reservations. In a combinatory example, an initial maximum quantity of resource reservations may be preconfigured and/or indicated by the base station, and the UE 120a may determine an updated maximum quantity of resource reservations using one or more factors as described above.

Additionally, or alternatively, the UE 120a selects the subset of the set of resource reservations based at least in part on a time window. For example, a length of the time window may be represented by Tₓ. Therefore, in one example, when Tₓ=4, the UE 120a selects resource reservations 503a, 503b, 503c, 503d, 503e, 503f, and 503g. In another example, when Tₓ=6, the UE 120a may select resource reservations 503a, 503b, 503c, 503d, 503e, 503f, 503g, 503h, 503i, and 503j. In some aspects, the UE 120a may discard, from the memory, stored data associated with resource reservations, from the set of resource reservations, that do not satisfy the time window. Accordingly, in example 500, the UE 120a may discard data associated with resource reservations 503k, 503l, 503m, and 503n. Accordingly, the UE 120a may reduce memory overhead.

In some aspects, the length of the time window is a programmed (and/or otherwise preconfigured) value stored in the memory of the UE 120a (e.g., according to 3GPP specifications and/or another standard). Additionally, or alternatively, the length of the time window may be indicated by a base station (e.g., as described in connection with FIG. 6). Additionally, or alternatively, the UE 120a may determine the length of the time window based at least in part on a maximum transmission resource available, a maximum MCS, a fixed MCS, a network congestion parameter, a traffic pattern, an indication from an application layer of the UE 120a, or a combination thereof. For example, the UE 120a may select a longer length of the time window based on a larger maximum transmission resource available, a larger maximum MCS (e.g., associated with a sidelink channel to be used), a larger fixed MCS (e.g., associated with the sidelink channel to be used), a larger network congestion parameter (e.g., a larger CBR), a traffic pattern (e.g., a larger data rate, a larger average packet size, a shorter periodicity, and/or a larger inter-arrival time associated with the one or more sidelink channels), an indication from an application layer of the UE 120a (e.g., an indication that higher reliability and/or quality, such as QoS, is required), or a combination thereof. In some aspects, the UE 120a may use a formula, a table, and/or another data structure that maps one or more of the factors described above to a value for the length of the time window. In a combinatory example, an initial length of the time window may be preconfigured and/or indicated by the base station, and the UE 120a may determine an updated length of the time window using one or more factors as described above.

In a combinatory example, the UE 120a may use a maximum quantity of resource reservations with a time window. In one example, when N=8 and Tₓ=7, the UE 120a selects resource reservations 503a, 503b, 503c, 503d, 503e, 503f, and 503g, and then includes one of resource reservations 503h, 503i, and 503j based at least in part on signal strengths associated with the set of messages, distances associated with the set of messages, identifiers included in the set of messages, sizes associated with the set of resource reservations, amount of resources reserved with the set of messages, periodicities of the resources reserved with the set of messages, or a combination thereof. For example, the UE 120a may select the resource reservation associated with a strongest signal strength, a shortest distance, a largest size, a largest amount of resources, and/or a shortest periodicity. Additionally, or alternatively, the UE 120a may prioritize any of the resource reservations 503h, 503i, and 503j associated with identifiers (e.g., UE IDs) included on a list stored in the memory of the UE 120a (e.g., a list of usual interferers). In some aspects, the UE 120a may generate a score using two or more of the factors described above and select the resource reservation associated with the highest score.

Additionally, or alternatively, the UE 120a selects the subset of the set of resource reservations based at least in part on a retransmission threshold. For example, the retransmission threshold may be represented by R. Therefore, in one example, when R=1, the UE 120a selects resource reservations associated with initial transmissions but not resource reservations associated with retransmissions. In some aspects, the UE 120a may discard, from the memory, stored data associated with resource reservations, from the set of resource reservations, that do not satisfy the retransmission threshold. Accordingly, the UE 120a may reduce memory overhead.

In some aspects, the retransmission threshold is a programmed (and/or otherwise preconfigured) value stored in the memory of the UE 120a (e.g., according to 3GPP specifications and/or another standard). Additionally, or alternatively, the retransmission threshold may be indicated by a base station (e.g., as described in connection with FIG. 6). Additionally, or alternatively, the UE 120a may determine the retransmission threshold based at least in part on a maximum transmission resource available, a maximum MCS, a fixed MCS, a network congestion parameter, a traffic pattern, an indication from an application layer of the UE 120a, or a combination thereof. For example, the UE 120a may select a larger retransmission threshold based on a larger maximum transmission resource available, a larger maximum MCS (e.g., associated with a sidelink channel to be used), a larger fixed MCS (e.g., associated with the sidelink channel to be used), a larger network congestion parameter (e.g., a larger CBR), a traffic pattern (e.g., a larger data rate, a larger average packet size, a shorter periodicity, and/or a larger inter-arrival time associated with the one or more sidelink channels), an indication from an application layer of the UE 120a (e.g., an indication that higher reliability and/or quality, such as QoS, is required), or a combination thereof. In some aspects, the UE 120a may use a formula, a table, and/or another data structure that maps one or more of the factors described above to a value for the retransmission threshold. In a combinatory example, an initial retransmission threshold may be preconfigured and/or indicated by the base station, and the UE 120a may determine an updated retransmission threshold using one or more factors as described above.

In a combinatory example, the UE 120a may use a retransmission threshold with a maximum quantity of resource reservations and/or a time window. Therefore, in one example, when Tₓ=4 and R=1, the UE 120a selects resource reservations from resource reservations 503a, 503b, 503c, 503d, 503e, 503f, and 503g that are associated with an initial transmission. In another example, when N=7 and R=2, the UE 120a selects resource reservations from resource reservations 503a, 503b, 503c, 503d, 503e, 503f, and 503g that are associated with an initial transmission or a first retransmission. In another example, when N=9 and R=1, the UE 120a may select resource reservations 503a, 503b, 503c, 503d, 503e, 503f, and 503g and then include two of resource reservations 503h, 503i, and 503j based at least in part on which of resource reservations 503h, 503i, and 503j are associated with an initial transmission. In another example, when N=8, Tₓ=7, and R=1, the UE 120a selects resource reservations 503a, 503b, 503c, 503d, 503e, 503f, and 503g and then includes one of resource reservations 503h, 503i, and 503j based at least in part on which of resource reservations 503h, 503i, and 503j are associated with an initial transmission.

Additionally, or alternatively, the UE 120a selects the subset of the set of resource reservations based at least in part on a hop count threshold. The hop count for a resource reservation indicates a quantity of UEs that have previously forwarded the resource reservation before the UE 120a receives the resource reservation. For example, the hop count threshold may be represented by M. Therefore, in one example, when M=0, the UE 120a selects resource reservations received from a reserving UE and not resource reservations that were forwarded to the UE 120a. In some aspects, the UE 120a may discard, from the memory, stored data associated with resource reservations, from the set of resource reservations, that do not satisfy the hop count threshold. Accordingly, the UE 120a may reduce memory overhead.

In some aspects, the hop count threshold is a programmed (and/or otherwise preconfigured) value stored in the memory of the UE 120a (e.g., according to 3GPP specifications and/or another standard). Additionally, or alternatively, the hop count threshold may be indicated by a base station (e.g., as described in connection with FIG. 6). Additionally, or alternatively, the UE 120a may determine the hop count threshold based at least in part on a maximum transmission resource available, a maximum MCS, a fixed MCS, a network congestion parameter, a traffic pattern, an indication from an application layer of the UE 120a, or a combination thereof. For example, the UE 120a may select a larger hop count threshold based on a larger maximum transmission resource available, a larger maximum MCS (e.g., associated with a sidelink channel to be used), a larger fixed MCS (e.g., associated with the sidelink channel to be used), a larger network congestion parameter (e.g., a larger CBR), a traffic pattern (e.g., a larger data rate, a larger average packet size, a shorter periodicity, and/or a larger inter-arrival time associated with the one or more sidelink channels), an indication from an application layer of the UE 120a (e.g., an indication that higher reliability and/or quality, such as QoS, is required), or a combination thereof. In some aspects, the UE 120a may use a formula, a table, and/or another data structure that maps one or more of the factors described above to a value for the hop count threshold. In a combinatory example, an initial hop count threshold may be preconfigured and/or indicated by the base station, and the UE 120a may determine an updated hop count threshold using one or more factors as described above.

In a combinatory example, the UE 120a may use a hop count threshold with a retransmission threshold, a maximum quantity of resource reservations, and/or a time window. Therefore, in one example, when Tₓ=4, M=0, and R=1, the UE 120a selects resource reservations from resource reservations 503a, 503b, 503c, 503d, 503e, 503f, and 503g that are associated with an initial transmission and were not forwarded to the UE 120a. In another example, when N=7, M=1, R=2, the UE 120a selects resource reservations from resource reservations 503a, 503b, 503c, 503d, 503e, 503f, and 503g that are associated with an initial transmission or a first retransmission and that were not forwarded more than one time before reaching the UE 120a. In another example, when N=9 and M=0, the UE 120a may select resource reservations 503a, 503b, 503c, 503d, 503e, 503f, and 503g and then include two of resource reservations 503h, 503i, and 503j based at least in part on which of resource reservations 503h, 503i, and 503j were not forwarded to the UE 120a. In another example, when N=8, Tₓ=7, and M=0, the UE 120a selects resource reservations 503a, 503b, 503c, 503d, 503e, 503f, and 503g and then includes one of resource reservations 503h, 503i, and 503j based at least in part on which of resource reservations 503h, 503i, and 503j were not forwarded to the UE 120a.

Additionally, or alternatively, the UE 120a selects the subset of the set of resource reservations based at least in part on a resource/subchannel threshold. For example, the resource/subchannel threshold may be represented by N_{SC}. Therefore, in one example, when N_{SC}=1, the UE 120a selects resource reservations that are associated with more than one subchannel. In another example, when N_{SC}=3, the UE 120a selects resource reservations that are associated with more than three resources (e.g., more than 3 RBs, more than 3 resource elements (REs), more than 3 symbols, and/or more than 3 slots, among other examples). In some aspects, the UE 120a may discard, from the memory, stored data associated with resource reservations, from the set of resource reservations, that do not satisfy the resource/subchannel threshold. Accordingly, the UE 120a may reduce memory overhead.

In some aspects, the resource/subchannel threshold is a programmed (and/or otherwise preconfigured) value stored in the memory of the UE 120a (e.g., according to 3GPP specifications and/or another standard). Additionally, or alternatively, the resource/subchannel threshold may be indicated by a base station (e.g., as described in connection with FIG. 6). Additionally, or alternatively, the UE 120a may determine the resource/subchannel threshold based at least in part on a maximum transmission resource available, a maximum MCS, a fixed MCS, a network congestion parameter, a traffic pattern, an indication from an application layer of the UE 120a, or a combination thereof. For example, the UE 120a may select a larger resource/subchannel threshold based on a larger maximum transmission resource available, a larger maximum MCS (e.g., associated with a sidelink channel to be used), a larger fixed MCS (e.g., associated with the sidelink channel to be used), a larger network congestion parameter (e.g., a larger CBR), a traffic pattern (e.g., a larger data rate, a larger average packet size, a shorter periodicity, and/or a larger inter-arrival time associated with the one or more sidelink channels), an indication from an application layer of the UE 120a (e.g., an indication that higher reliability and/or quality, such as QoS, is required), or a combination thereof. In some aspects, the UE 120a may use a formula, a table, and/or another data structure that maps one or more of the factors described above to a value for the resource/subchannel threshold. In a combinatory example, an initial resource/subchannel threshold may be preconfigured and/or indicated by the base station, and the UE 120a may determine an updated resource/subchannel threshold using one or more factors as described above.

In a combinatory example, the UE 120a may use a resource/subchannel threshold with a hop count threshold, a retransmission threshold, a maximum quantity of resource reservations, and/or a time window. Therefore, in one example, when Tₓ=4, N_{SC}=1, and R=1, the UE 120a selects resource reservations from resource reservations 503a, 503b, 503c, 503d, 503e, 503f, and 503g that are associated with an initial transmission and indicate more than one subchannel or resource. In another example, when N=7, M=1, N_{SC}=2, the UE 120a selects resource reservations from resource reservations 503a, 503b, 503c, 503d, 503e, 503f, and 503g that are associated with an initial transmission or a first retransmission and indicate more than two subchannels or resources. In another example, when N=9 and N_{SC}=1, the UE 120a may select resource reservations 503a, 503b, 503c, 503d, 503e, 503f, and 503g and then include two of resource reservations 503h, 503i, and 503j based at least in part on which of resource reservations 503h, 503i, and 503j are associated with more than one subchannel or resource. In another example, when N=8, Tₓ=7, and N_{SC}=2, the UE 120a selects resource reservations 503a, 503b, 503c, 503d, 503e, 503f, and 503g and then includes one of resource reservations 503h, 503i, and 503j based at least in part on which of resource reservations 503h, 503i, and 503j are associated with more than two subchannels or resources.

Accordingly, the UE 120a may transmit, to the UE 120b, a resource information message that indicates the subset of the set of resource reservations. For example, the resource information message may include SCI and/or another sidelink message from the UE 120a to the UE 120b.

By using techniques as described in connection with FIG. 5, the UE 120a transmits a resource information message 505 indicating a subset of resource reservations out of a set of resource reservations associated with a corresponding set of messages 503a-503n received on one or more sidelink channels. As a result, the UE 120a conserves power and processing resources by reducing a quantity of resource reservations indicated in the resource information message 505. Additionally, reducing the quantity of resource reservations indicated in the resource information message 505 conserves network resources on the sidelink channel and decreases interference for nearby UEs. In some aspects, the UE 120a may discard resource reservations that are not selected for the subset from the queue 501 to additionally reduce memory overhead at the UE 120a.

As indicated above, FIG. 5 is provided as an example. Other examples may differ from what is described with respect to FIG. 5.

FIG. 6 is a diagram illustrating an example 600 associated with forwarding sidelink resource reservation information, in accordance with the present disclosure. As shown in FIG. 6, a base station 110 and a UE 120a may communicate with one another (e.g., using a Uu interface of a wireless communication network, such as wireless network 100 of FIG. 1). Additionally, as shown in FIG. 6, the UE 120a may communicate with other UEs including a UE 120b (e.g., using PC5 interfaces of one or more sidelink channels as described in connection with FIGS. 3-4).

As shown by reference number 605, the base station 110 may transmit, and the UE 120a may receive, at least one parameter to determine a subset, from a set of resource reservations, to include in a resource information message on the one or more sidelink channels. For example, the at least one parameter may be included in a radio resource control (RRC) message, downlink control information (DCI), and/or another signal from the base station 110 to the UE 120a.

In some aspects, and as described in connection with FIG. 5, the at least one parameter may include a maximum quantity of resource reservations. The base station 110 may select the maximum quantity of resource reservations from a plurality of programmed (and/or otherwise preconfigured) values stored in a memory of the base station 110 (e.g., according to 3GPP specifications and/or another standard). Additionally, or alternatively, the base station 110 may determine the maximum quantity of resource reservations based at least in part on a maximum transmission resource available, a maximum MCS, a fixed MCS, a network congestion parameter, a traffic pattern, an indication from an application layer of the UE 120a, or a combination thereof, as described in connection with FIG. 5.

Additionally, or alternatively, and as described in connection with FIG. 5, the at least one parameter may include a length of a time window. The base station 110 may select the length of a time window from a plurality of programmed (and/or otherwise preconfigured) values stored in a memory of the base station 110 (e.g., according to 3GPP specifications and/or another standard). Additionally, or alternatively, the base station 110 may determine the length of a time window based at least in part on a maximum transmission resource available, a maximum MCS, a fixed MCS, a network congestion parameter, a traffic pattern, an indication from an application layer of the UE 120a, or a combination thereof, as described in connection with FIG. 5.

Additionally, or alternatively, and as described in connection with FIG. 5, the at least one parameter may include a retransmission threshold. The base station 110 may select the retransmission threshold from a plurality of programmed (and/or otherwise preconfigured) values stored in a memory of the base station 110 (e.g., according to 3GPP specifications and/or another standard). Additionally, or alternatively, the base station 110 may determine the retransmission threshold based at least in part on a maximum transmission resource available, a maximum MCS, a fixed MCS, a network congestion parameter, a traffic pattern, an indication from an application layer of the UE 120a, or a combination thereof, as described in connection with FIG. 5.

Additionally, or alternatively, and as described in connection with FIG. 5, the at least one parameter may include a hop count threshold. The base station 110 may select the hop count threshold from a plurality of programmed (and/or otherwise preconfigured) values stored in a memory of the base station 110 (e.g., according to 3GPP specifications and/or another standard). Additionally, or alternatively, the base station 110 may determine the hop count threshold based at least in part on a maximum transmission resource available, a maximum MCS, a fixed MCS, a network congestion parameter, a traffic pattern, an indication from an application layer of the UE 120a, or a combination thereof, as described in connection with FIG. 5.

Additionally, or alternatively, and as described in connection with FIG. 5, the at least one parameter may include a resource/subchannel threshold. The base station 110 may select the resource/subchannel threshold from a plurality of programmed (and/or otherwise preconfigured) values stored in a memory of the base station 110 (e.g., according to 3GPP specifications and/or another standard). Additionally, or alternatively, the base station 110 may determine the resource/subchannel threshold based at least in part on a maximum transmission resource available, a maximum MCS, a fixed MCS, a network congestion parameter, a traffic pattern, an indication from an application layer of the UE 120a, or a combination thereof, as described in connection with FIG. 5.

As shown by reference number 610, the UE 120a may receive, on one or more sidelink channels, a set of messages indicating a corresponding set of resource reservations. For example, the UE 120a may decode one or more SCI messages that indicate the corresponding set of resource reservations.

As shown by reference number 615, the UE 120a may select a subset of the set of resource reservations. For example, the UE 120a may select the subset as described in connection with FIG. 5.

As shown by reference number 620, the UE 120a may transmit, and the UE 120b may receive, a resource information message that indicates a subset of the set of resource reservations. For example, the resource information message may include SCI and/or another sidelink signal from the UE 120a to the UE 120b. Accordingly, the UE 120b may schedule a transmission to the UE 120a based at least in part on the resource information message. For example, the UE 120b may transmit an SCI message to the UE 120a to indicate one or more resources that do not conflict (e.g., overlap in part) with the reserved resources indicated in the resource information message. Accordingly, the UE 120b may transmit data (e.g., over a PSSCH) to the UE 120a using the one or more resources indicated by the SCI message.

By using techniques as described in connection with FIG. 6, the UE 120a transmits, and the UE 120b receives, a resource information message indicating a subset of resource reservations out of a set of resource reservations associated with a corresponding set of messages received on one or more sidelink channels. As a result, the UE 120a conserves power and processing resources at the UE 120a and the UE 120b by reducing a quantity of resource reservations indicated in the resource information message. Additionally, reducing the quantity of resource reservations indicated in the resource information message conserves network resources on the sidelink channel and decreases interference for nearby UEs. In some aspects, the UE 120a may discard resource reservations that are not selected for the subset from a memory of the UE 120a to additionally reduce memory overhead at the UE 120a.

As indicated above, FIG. 6 is provided as an example. Other examples may differ from what is described with respect to FIG. 6.

FIG. 7 is a diagram illustrating an example process 700 performed, for example, by a first UE, in accordance with the present disclosure. Example process 700 is an example where the first UE (e.g., UE 120 and/or apparatus 900 of FIG. 9) performs operations associated with forwarding sidelink resource reservation information.

As shown in FIG. 7, in some aspects, process 700 may include receiving, on one or more sidelink channels, a set of messages indicating a corresponding set of resource reservations (block 710). For example, the UE (e.g., using communication manager 140 and/or reception component 902, depicted in FIG. 9) may receive, on one or more sidelink channels, a set of messages indicating a corresponding set of resource reservations, as described herein.

As further shown in FIG. 7, in some aspects, process 700 may include transmitting, to a second UE, a resource information message that indicates a subset of the set of resource reservations (block 720). For example, the UE (e.g., using communication manager 140 and/or transmission component 904, depicted in FIG. 9) may transmit, to a second UE, a resource information message that indicates a subset of the set of resource reservations, as described herein.

Process 700 may include additional aspects, such as any single aspect or any combination of aspects described below and/or in connection with one or more other processes described elsewhere herein.

In a first aspect, the subset of the set of resource reservations are associated with one or more messages, from the set of messages, that were received earlier than remaining messages, from the set of messages, associated with resource reservations, of the set of resource reservations, not included in the subset.

In a second aspect, alone or in combination with the first aspect, the subset of the set of resource reservations are selected (e.g., using communication manager 140 and/or selection component 908, depicted in FIG. 9) based at least in part on a maximum quantity of resource reservations.

In a third aspect, alone or in combination with one or more of the first and second aspects, the maximum quantity of resource reservations is a preconfigured value stored in a memory of the UE.

In a fourth aspect, alone or in combination with one or more of the first through third aspects, process 700 further includes receiving (e.g., using communication manager 140 and/or reception component 902), from a base station, an indication of the maximum quantity of resource reservations.

In a fifth aspect, alone or in combination with one or more of the first through fourth aspects, process 700 further includes determining (e.g., using communication manager 140 and/or determination component 910, depicted in FIG. 9) the maximum quantity of resource reservations based at least in part on a maximum transmission resource available, a maximum MCS, a fixed MCS, a network congestion parameter, a traffic pattern, an indication from an application layer of the UE, or a combination thereof.

In a sixth aspect, alone or in combination with one or more of the first through fifth aspects, the subset of the set of resource reservations are selected (e.g., using communication manager 140 and/or selection component 908) based at least in part on a time window.

In a seventh aspect, alone or in combination with one or more of the first through sixth aspects, a length of the time window is a preconfigured value stored in a memory of the UE.

In an eighth aspect, alone or in combination with one or more of the first through seventh aspects, process 700 further includes receiving (e.g., using communication manager 140 and/or reception component 902), from a base station, an indication of a length of the time window.

In a ninth aspect, alone or in combination with one or more of the first through eighth aspects, process 700 further includes determining (e.g., using communication manager 140 and/or determination component 910) a length of the time window based at least in part on a maximum transmission resource available, a maximum MCS, a fixed MCS, a network congestion parameter, a traffic pattern, an indication from an application layer of the UE, or a combination thereof.

In a tenth aspect, alone or in combination with one or more of the first through ninth aspects, the subset of the set of resource reservations are selected (e.g., using communication manager 140 and/or selection component 908) based at least in part on signal strengths associated with the set of messages, distances associated with the set of messages, identifiers included in the set of messages, sizes associated with the set of resource reservations, amount of resources reserved with the set of messages, periodicities of the resources reserved with the set of messages, or a combination thereof.

In an eleventh aspect, alone or in combination with one or more of the first through tenth aspects, the subset of the set of resource reservations are associated with a retransmission count that satisfies a retransmission threshold.

In a twelfth aspect, alone or in combination with one or more of the first through eleventh aspects, process 700 further includes discarding (e.g., using communication manager 140 and/or deletion component 912, depicted in FIG. 9), from a memory of the UE, stored data associated with resource reservations, from the set of resource reservations, that are associated with a retransmission count that does not satisfy the retransmission threshold.

In a thirteenth aspect, alone or in combination with one or more of the first through twelfth aspects, the retransmission threshold is a preconfigured value stored in a memory of the UE.

In a fourteenth aspect, alone or in combination with one or more of the first through thirteenth aspects, process 700 further includes receiving (e.g., using communication manager 140 and/or reception component 902), from a base station, an indication of the retransmission threshold.

In a fifteenth aspect, alone or in combination with one or more of the first through fourteenth aspects, process 700 further includes determining (e.g., using communication manager 140 and/or determination component 910) the retransmission threshold based at least in part on a maximum transmission resource available, a maximum MCS, a fixed MCS, a network congestion parameter, a traffic pattern, an indication from an application layer of the UE, or a combination thereof.

In a sixteenth aspect, alone or in combination with one or more of the first through fifteenth aspects, the subset of the set of resource reservations are associated with a hop count that satisfies a hop count threshold.

In a seventeenth aspect, alone or in combination with one or more of the first through sixteenth aspects, process 700 further includes discarding (e.g., using communication manager 140 and/or deletion component 912), from a memory of the UE, stored data associated with resource reservations, from the set of resource reservations, that are associated with a hop count that does not satisfy the hop count threshold.

In an eighteenth aspect, alone or in combination with one or more of the first through seventeenth aspects, the hop count threshold is a preconfigured value stored in a memory of the UE.

In a nineteenth aspect, alone or in combination with one or more of the first through eighteenth aspects, process 700 further includes receiving (e.g., using communication manager 140 and/or reception component 902), from a base station, an indication of the hop count threshold.

In a twentieth aspect, alone or in combination with one or more of the first through nineteenth aspects, process 700 further includes determining (e.g., using communication manager 140 and/or determination component 910) the hop count threshold based at least in part on a maximum transmission resource available, a maximum MCS, a fixed MCS, a network congestion parameter, a traffic pattern, an indication from an application layer of the UE, or a combination thereof.

In a twenty-first aspect, alone or in combination with one or more of the first through twentieth aspects, the subset of the set of resource reservations are associated with a quantity of resources/subchannels that satisfies a resource/subchannel threshold.

In a twenty-second aspect, alone or in combination with one or more of the first through twenty-first aspects, process 700 further includes discarding (e.g., using communication manager 140 and/or deletion component 912), from a memory of the UE, stored data associated with resource reservations, from the set of resource reservations, that are associated with a quantity of resources/subchannels that does not satisfy the resource/subchannel threshold.

In a twenty-third aspect, alone or in combination with one or more of the first through twenty-second aspects, the resource/subchannel threshold is a preconfigured value stored in a memory of the UE.

In a twenty-fourth aspect, alone or in combination with one or more of the first through twenty-third aspects, process 700 further includes receiving (e.g., using communication manager 140 and/or reception component 902), from a base station, an indication of the resource/subchannel threshold.

In a twenty-fifth aspect, alone or in combination with one or more of the first through twenty-fourth aspects, process 700 further includes determining (e.g., using communication manager 140 and/or determination component 910) the resource/subchannel threshold based at least in part on a maximum transmission resource available, a maximum MCS, a fixed MCS, a network congestion parameter, a traffic pattern, an indication from an application layer of the UE, or a combination thereof.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110 and/or apparatus 1000 of FIG. 10) performs operations associated with forwarding sidelink resource reservation information.

As shown in FIG. 8, in some aspects, process 800 may include transmitting, to a UE (e.g., UE 120 and/or apparatus 900 of FIG. 9), at least one parameter to determine a subset, from a set of resource reservations, to include in a resource information message on one or more sidelink channels (block 810). For example, the base station (e.g., using communication manager 150 and/or transmission component 1004, depicted in FIG. 10) may transmit, to a UE, at least one parameter to determine a subset, from a set of resource reservations, to include in a resource information message on one or more sidelink channels, as described herein.

As further shown in FIG. 8, in some aspects, process 800 may include receiving, from the UE, an acknowledgement of the at least one parameter (block 820). For example, the base station (e.g., using communication manager 150 and/or reception component 1002, depicted in FIG. 10) may receive, from the UE, an acknowledgement of the at least one parameter, as described herein.

Process 800 may include additional aspects, such as any single aspect or any combination of aspects described below and/or in connection with one or more other processes described elsewhere herein.

In a first aspect, the at least one parameter includes a maximum quantity of resource reservations.

In a second aspect, alone or in combination with the first aspect, the maximum quantity of resource reservations is selected (e.g., using communication manager 150 and/or selection component 1008, depicted in FIG. 10) from a plurality of preconfigured values stored in a memory of the base station.

In a third aspect, alone or in combination with one or more of the first and second aspects, the at least one parameter includes a length of a time window.

In a fourth aspect, alone or in combination with one or more of the first through third aspects, the length of the time window is selected (e.g., using communication manager 150 and/or selection component 1008) from a plurality of preconfigured values stored in a memory of the base station.

In a fifth aspect, alone or in combination with one or more of the first through fourth aspects, the at least one parameter includes a retransmission threshold.

In a sixth aspect, alone or in combination with one or more of the first through fifth aspects, the retransmission threshold is selected (e.g., using communication manager 150 and/or selection component 1008) from a plurality of preconfigured values stored in a memory of the base station.

In a seventh aspect, alone or in combination with one or more of the first through sixth aspects, the at least one parameter includes a hop count threshold.

In an eighth aspect, alone or in combination with one or more of the first through seventh aspects, the hop count threshold is selected (e.g., using communication manager 150 and/or selection component 1008) from a plurality of preconfigured values stored in a memory of the base station.

In a ninth aspect, alone or in combination with one or more of the first through eighth aspects, the at least one parameter includes a resource/subchannel threshold.

In a tenth aspect, alone or in combination with one or more of the first through ninth aspects, the resource/subchannel threshold is selected (e.g., using communication manager 150 and/or selection component 1008) from a plurality of preconfigured values stored in a memory of the base station.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of a selection component 908, a determination component 910, and/or a deletion component 912, among other examples.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

In some aspects, the reception component 902 may receive, on one or more sidelink channels, a set of messages indicating a corresponding set of resource reservations. Accordingly, the transmission component 904 may transmit (e.g., to a UE), a resource information message that indicates a subset of the set of resource reservations. For example, the selection component 908 may select the subset as described in connection with FIG. 5. The selection component 908 may include a MIMO detector, a receive processor, a transmit MIMO processor, a transmit processor, a controller/processor, a memory, or a combination thereof, of the UE described in connection with FIG. 2.

In some aspects, the reception component 902 may receive (e.g., from the apparatus 906, such as a base station), an indication of a maximum quantity of resource reservations. Additionally, or alternatively, the determination component 910 may determine the maximum quantity of resource reservations based at least in part on a maximum transmission resource available, a maximum MCS, a fixed MCS, a network congestion parameter, a traffic pattern, an indication from an application layer of the apparatus 900, or a combination thereof. The determination component 910 may include a receive processor, a transmit processor, a controller/processor, a memory, or a combination thereof, of the UE described in connection with FIG. 2.

Additionally, or alternatively, the reception component 902 may receive (e.g., from the apparatus 906) an indication of a length of a time window. Additionally, or alternatively, the determination component 910 may determine a length of the time window based at least in part on a maximum transmission resource available, a maximum MCS, a fixed MCS, a network congestion parameter, a traffic pattern, an indication from an application layer of the apparatus 900, or a combination thereof.

Additionally, or alternatively, the reception component 902 may receive (e.g., from the apparatus 906) an indication of a retransmission threshold. Additionally, or alternatively, the determination component 910 may determine the retransmission threshold based at least in part on a maximum transmission resource available, a maximum MCS, a fixed MCS, a network congestion parameter, a traffic pattern, an indication from an application layer of the apparatus 900, or a combination thereof. In some aspects, the deletion component 912 may discard (e.g., from a memory of the apparatus 900) stored data associated with resource reservations, from the set of resource reservations, that are associated with a retransmission count that does not satisfy the retransmission threshold. The deletion component 912 may include a receive processor, a transmit processor, a controller/processor, a memory, or a combination thereof, of the UE described in connection with FIG. 2.

Additionally, or alternatively, the reception component 902 may receive (e.g., from the apparatus 906) an indication of a hop count threshold. Additionally, or alternatively, the determination component 910 may determine the hop count threshold based at least in part on a maximum transmission resource available, a maximum MCS, a fixed MCS, a network congestion parameter, a traffic pattern, an indication from an application layer of the apparatus 900, or a combination thereof. In some aspects, the deletion component 912 may discard (e.g., from a memory of the apparatus 900) stored data associated with resource reservations, from the set of resource reservations, that are associated with a hop count that does not satisfy the hop count threshold.

Additionally, or alternatively, the reception component 902 may receive (e.g., from the apparatus 906) an indication of a resource/subchannel threshold. Additionally, or alternatively, the determination component 910 may determine the resource/subchannel threshold based at least in part on a maximum transmission resource available, a maximum MCS, a fixed MCS, a network congestion parameter, a traffic pattern, an indication from an application layer of the apparatus 900, or a combination thereof. In some aspects, the deletion component 912 may discard (e.g., from a memory of the apparatus 900) stored data associated with resource reservations, from the set of resource reservations, that are associated with a quantity of resources/subchannels that does not satisfy the resource/subchannel threshold.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include a selection component 1008, among other examples.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the base station described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the base station described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the base station described in connection with FIG. 2. In some aspects, the transmission component 1004 may be co-located with the reception component 1002 in a transceiver.

In some aspects, the transmission component 1004 may transmit (e.g., to the apparatus 1006, such as a UE) at least one parameter to determine a subset, from a set of resource reservations, to include in a resource information message on one or more sidelink channels. In some aspects, the selection component 1008 may select the at least one parameter from a plurality of preconfigured values stored in a memory of the apparatus 1000. The selection component 1008 may include a MIMO detector, a receive processor, a transmit MIMO processor, a transmit processor, a controller/processor, a memory, or a combination thereof, of the base station described in connection with FIG. 2.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first user equipment (UE), comprising: receiving, on one or more sidelink channels, a set of messages indicating a corresponding set of resource reservations; and transmitting, to a second UE, a resource information message that indicates a subset of the set of resource reservations.

Aspect 2: The method of Aspect 1, wherein the subset of the set of resource reservations are associated with one or more messages, from the set of messages, that were received earlier than remaining messages, from the set of messages, associated with resource reservations, of the set of resource reservations, not included in the subset.

Aspect 3: The method of any of Aspects 1 through 2, wherein the subset of the set of resource reservations are selected based at least in part on a maximum quantity of resource reservations.

Aspect 4: The method of Aspect 3, wherein the maximum quantity of resource reservations is a preconfigured value stored in a memory of the UE.

Aspect 5: The method of any of Aspects 3 through 4, further comprising: receiving, from a base station, an indication of the maximum quantity of resource reservations.

Aspect 6: The method of any of Aspects 3 through 5, further comprising: determining the maximum quantity of resource reservations based at least in part on a maximum transmission resource available, a maximum modulation and coding scheme (MCS), a fixed MCS, a network congestion parameter, a traffic pattern, an indication from an application layer of the UE, or a combination thereof.

Aspect 7: The method of any of Aspects 1 through 6, wherein the subset of the set of resource reservations are selected based at least in part on a time window.

Aspect 8: The method of Aspect 7, wherein a length of the time window is a preconfigured value stored in a memory of the UE.

Aspect 9: The method of any of Aspects 7 through 8, further comprising: receiving, from a base station, an indication of a length of the time window.

Aspect 10: The method of any of Aspects 7 through 9, further comprising: determining a length of the time window based at least in part on a maximum transmission resource available, a maximum modulation and coding scheme (MCS), a fixed MCS, a network congestion parameter, a traffic pattern, an indication from an application layer of the UE, or a combination thereof.

Aspect 11: The method of any of Aspects 1 through 10, wherein the subset of the set of resource reservations are selected based at least in part on signal strengths associated with the set of messages, distances associated with the set of messages, identifiers included in the set of messages, sizes associated with the set of resource reservations, amount of resources reserved with the set of messages, periodicities of the resources reserved with the set of messages, or a combination thereof.

Aspect 12: The method of any of Aspects 1 through 11, wherein the subset of the set of resource reservations are associated with a retransmission count that satisfies a retransmission threshold.

Aspect 13: The method of Aspect 12, further comprising: discarding, from a memory of the UE, stored data associated with resource reservations, from the set of resource reservations, that are associated with a retransmission count that does not satisfy the retransmission threshold.

Aspect 14: The method of any of Aspects 12 through 13, wherein the retransmission threshold is a preconfigured value stored in a memory of the UE.

Aspect 15: The method of any of Aspects 12 through 14, further comprising: receiving, from a base station, an indication of the retransmission threshold.

Aspect 16: The method of any of Aspects 12 through 15, further comprising: determining the retransmission threshold based at least in part on a maximum transmission resource available, a maximum modulation and coding scheme (MCS), a fixed MCS, a network congestion parameter, a traffic pattern, an indication from an application layer of the UE, or a combination thereof.

Aspect 17: The method of any of Aspects 1 through 16, wherein the subset of the set of resource reservations are associated with a hop count that satisfies a hop count threshold.

Aspect 18: The method of Aspect 17, further comprising: discarding, from a memory of the UE, stored data associated with resource reservations, from the set of resource reservations, that are associated with a hop count that does not satisfy the hop count threshold.

Aspect 19: The method of any of Aspects 17 through 18, wherein the hop count threshold is a preconfigured value stored in a memory of the UE.

Aspect 20: The method of any of Aspects 17 through 19, further comprising: receiving, from a base station, an indication of the hop count threshold.

Aspect 21: The method of any of Aspects 17 through 20, further comprising: determining the hop count threshold based at least in part on a maximum transmission resource available, a maximum modulation and coding scheme (MCS), a fixed MCS, a network congestion parameter, a traffic pattern, an indication from an application layer of the UE, or a combination thereof.

Aspect 22: The method of any of Aspects 1 through 21, wherein the subset of the set of resource reservations are associated with a quantity of resources/subchannels that satisfies a resource/subchannel threshold.

Aspect 23: The method of Aspect 22, further comprising: discarding, from a memory of the UE, stored data associated with resource reservations, from the set of resource reservations, that are associated with a quantity of resources/subchannels that does not satisfy the resource/subchannel threshold.

Aspect 24: The method of any of Aspects 22 through 23, wherein the resource/subchannel threshold is a preconfigured value stored in a memory of the UE.

Aspect 25: The method of any of Aspects 22 through 24, further comprising: receiving, from a base station, an indication of the resource/subchannel threshold.

Aspect 26: The method of any of Aspects 22 through 25, further comprising: determining the resource/subchannel threshold based at least in part on a maximum transmission resource available, a maximum modulation and coding scheme (MCS), a fixed MCS, a network congestion parameter, a traffic pattern, an indication from an application layer of the UE, or a combination thereof.

Aspect 27: A method of wireless communication performed by a base station, comprising: transmitting, to a user equipment (UE), at least one parameter to determine a subset, from a set of resource reservations, to include in a resource information message on one or more sidelink channels.

Aspect 28: The method of Aspect 27, wherein the at least one parameter includes a maximum quantity of resource reservations.

Aspect 29: The method of Aspect 28, wherein the maximum quantity of resource reservations is selected from a plurality of preconfigured values stored in a memory of the base station.

Aspect 30: The method of any of Aspects 27 through 29, wherein the at least one parameter includes a length of a time window.

Aspect 31: The method of Aspect 30, wherein the length of the time window is selected from a plurality of preconfigured values stored in a memory of the base station.

Aspect 32: The method of any of Aspects 27 through 31, wherein the at least one parameter includes a retransmission threshold.

Aspect 33: The method of Aspect 32, wherein the retransmission threshold is selected from a plurality of preconfigured values stored in a memory of the base station.

Aspect 34: The method of any of Aspects 27 through 33, wherein the at least one parameter includes a hop count threshold.

Aspect 35: The method of Aspect 34, wherein the hop count threshold is selected from a plurality of preconfigured values stored in a memory of the base station.

Aspect 36: The method of any of Aspects 27 through 35, wherein the at least one parameter includes a resource/subchannel threshold.

Aspect 37: The method of Aspect 36, wherein the resource/subchannel threshold is selected from a plurality of preconfigured values stored in a memory of the base station.

Aspect 38: An apparatus for wireless communication at a device, comprising a processor; memory coupled with the processor; and instructions stored in the memory and executable by the processor to cause the apparatus to perform the method of one or more of Aspects 1-26.

Aspect 39: A device for wireless communication, comprising a memory and one or more processors coupled to the memory, the one or more processors configured to perform the method of one or more of Aspects 1-26.

Aspect 40: An apparatus for wireless communication, comprising at least one means for performing the method of one or more of Aspects 1-26.

Aspect 41: A non-transitory computer-readable medium storing code for wireless communication, the code comprising instructions executable by a processor to perform the method of one or more of Aspects 1-26.

Aspect 42: A non-transitory computer-readable medium storing a set of instructions for wireless communication, the set of instructions comprising one or more instructions that, when executed by one or more processors of a device, cause the device to perform the method of one or more of Aspects 1-26.

Aspect 43: An apparatus for wireless communication at a device, comprising a processor; memory coupled with the processor; and instructions stored in the memory and executable by the processor to cause the apparatus to perform the method of one or more of Aspects 27-37.

Aspect 44: A device for wireless communication, comprising a memory and one or more processors coupled to the memory, the one or more processors configured to perform the method of one or more of Aspects 27-37.

Aspect 45: An apparatus for wireless communication, comprising at least one means for performing the method of one or more of Aspects 27-37.

Aspect 46: A non-transitory computer-readable medium storing code for wireless communication, the code comprising instructions executable by a processor to perform the method of one or more of Aspects 27-37.

Aspect 47: A non-transitory computer-readable medium storing a set of instructions for wireless communication, the set of instructions comprising one or more instructions that, when executed by one or more processors of a device, cause the device to perform the method of one or more of Aspects 27-37.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a first user equipment (UE), comprising:
one or more memories; and
one or more processors, coupled to the one or more memories, configured to:
receive, on one or more sidelink channels, a set of messages indicating a corresponding set of resource reservations; and
transmit, to a second UE, a resource information message that indicates a subset of the set of resource reservations.

2. The apparatus of claim 1, wherein the subset of the set of resource reservations are associated with one or more messages, from the set of messages, that were received earlier than remaining messages, from the set of messages, associated with resource reservations, of the set of resource reservations, not included in the subset.

3. The apparatus of claim 2, wherein the subset of the set of resource reservations are selected based at least in part on a maximum quantity of resource reservations.

4-6. (canceled)

7. The apparatus of claim 1, wherein the subset of the set of resource reservations are selected based at least in part on a time window.

8. The apparatus of claim 7, wherein a length of the time window is a preconfigured value stored in the one or more memories.

9. The apparatus of claim 7, wherein the one or more processors are further configured to:
receive an indication of a length of the time window.

10. The apparatus of claim 7, wherein the one or more processors are further configured to:
determine a length of the time window based at least in part on a maximum transmission resource available, a maximum modulation and coding scheme (MCS), a fixed MCS, a network congestion parameter, a traffic pattern, an indication from an application layer of the UE, or a combination thereof.

11. The apparatus of claim 1, wherein the subset of the set of resource reservations are selected based at least in part on signal strengths associated with the set of messages, distances associated with the set of messages, identifiers included in the set of messages, sizes associated with the set of resource reservations, amount of resources reserved with the set of messages, periodicities of the resources reserved with the set of messages, or a combination thereof.

12. The apparatus of claim 1, wherein the subset of the set of resource reservations are associated with a retransmission count that satisfies a retransmission threshold.

13. The apparatus of claim 12, wherein the one or more processors are further configured to:
discard, from the one or more memories, stored data associated with resource reservations, from the set of resource reservations, that are associated with a retransmission count that does not satisfy the retransmission threshold.

14-16. (canceled)

17. The apparatus of claim 1, wherein the subset of the set of resource reservations are associated with a hop count that satisfies a hop count threshold.

18. The apparatus of claim 17, wherein the one or more processors are further configured to:
discard, from the one or more memories, stored data associated with resource reservations, from the set of resource reservations, that are associated with a hop count that does not satisfy the hop count threshold.

19-21. (canceled)

22. The apparatus of claim 1, wherein the subset of the set of resource reservations are associated with a quantity of resources/subchannels that satisfies a resource/subchannel threshold.

23. The apparatus of claim 22, wherein the one or more processors are further configured to:
discard, from the one or more memories, stored data associated with resource reservations, from the set of resource reservations, that are associated with a quantity of resources/subchannels that does not satisfy the resource/subchannel threshold.

24-26. (canceled)

27. An apparatus for wireless communication at a network node, comprising:
one or more memories; and
one or more processors, coupled to the one or more memories, configured to:
transmit at least one parameter to determine a subset, from a set of resource reservations, to include in a resource information message on one or more sidelink channels.

28-29. (canceled)

30. The apparatus of claim 27, wherein the at least one parameter includes a length of a time window.

31. The apparatus of claim 30, wherein the length of the time window is selected from a plurality of preconfigured values stored in the one or more memories.

32-37. (canceled)

38. A method of wireless communication performed by a first user equipment (UE), comprising:
receiving, on one or more sidelink channels, a set of messages indicating a corresponding set of resource reservations; and
transmitting, to a second UE, a resource information message that indicates a subset of the set of resource reservations.

39. (canceled)

40. The method of claim 38, wherein the subset of the set of resource reservations are associated with one or more messages, from the set of messages, that were received earlier than remaining messages, from the set of messages, associated with resource reservations, of the set of resource reservations, not included in the subset.

41. The method of claim 38, wherein the subset of the set of resource reservations are selected based at least in part on a time window.
